(19) United States
(12) Patent Application Publication
(10) Pub. No.: US 2004/0008254 A1
(43) Pub. Date: Jan. 15, 2004

(54) Object protection device

(76) Inventors: Martin Rechsteiner, Mannedorf (CH); Brigitt Schmid, Plaffhausen (CH); Walter Lange, Regensdorf (CH)

Correspondence Address: BAKER & BOTTS, 30 ROCKEFELLER PLAZA, NEW YORK, NY, 10112

(21) Appl. No.: 10/456,437

(22) Filed: Jun. 5, 2003

(30) Foreign Application Priority Data
Jun. 10, 2002 (EP) 02012793.2

(51) Int. Cl. H04N 7/18

(52) U.S. Cl. 348/143; 348/152

(57) ABSTRACT

The object protection device (M) has an imaging sensor (1) for generating images of an object to be protected and its environment and evaluation electronics (2) for evaluating these images. The evaluation electronics (2) are provided in situ or on the sensor (1) and together with it form an autonomous device (M). Evaluation of the images takes place locally, and in normal cases there is no transfer of the images to a central unit (6). The imaging sensor (1) is formed by a CMOS camera and the evaluation electronics (2) are integrated therein or connected thereto.

The present invention relates to an object protection device with an imaging sensor for generating images of the object to be protected and its environment, and with evaluation electronics for evaluating these images.

### BACKGROUND OF THE INVENTION

Present-day devices for object protection, wherein objects are understood to be, for example, exhibition items in museums and such, in other words, portable and/or fixed displayed objects, as opposed to buildings, parked cars or aircraft, are either mechanical detectors which set off an alarm if said objects are disturbed, capacitive detectors which trigger an alarm if an object is approached too closely, or CCTV systems in which a security attendant monitors the exhibition rooms remotely, or were a centralized evaluation of video data takes place.

Mechanical and capacitive detectors, which are today generally considered obsolete due to the expense of installation and their susceptibility to false alarms, are continually being replaced by video monitoring. However, CCTV systems are not considered to provide adequate security since they are dependent on the attentiveness of a person observing a row of screens, which attentiveness diminishes over time and often as a result of a distracting event which may accompany an attempt to breach the security in place. Apart from this problem, an immense amount of data has to be transferred with CCTV systems.

### OBJECT OF THE INVENTION

The object of the present invention is to provide an object protection device which operates similarly to video monitoring, but which offers maximum security and does not depend on the concentration capacity and attentiveness of an attendant watching a wall of screens. This object is achieved according to the present invention by providing evaluation electronics in situ, in or on the sensor and together with it forms an autonomous device wherein evaluation of the images occurs locally, and in normal cases without the need to transfer the images to a central unit. The autonomous object protection device according to the present invention therefore combines the advantages of video monitoring, namely flexibility and low installation expense, with a high degree of security, since evaluation of the video signals occurs locally. Further, the present invention obviates the need to have large amounts of data constantly transferred to a central unit.

In a preferred embodiment of the object protection device according to the present invention, an imaging sensor is formed by a camera or a CMOS image sensor. The evaluation electronics are preferably integrated into the imaging sensor or connected to it.

In the event of an alarm, various variants are possible. In one preferred embodiment the imaging sensor is connected to a local alarm appliance, which is triggered by the evaluation electronics in the event of an alarm. The local alarm device can be a siren, actuatable via a relay, and separate from the device. Alternatively, it can be a miniature siren built into the device, or a voice synthesizer for programmed voice output.

In another preferred embodiment of the present invention, in the event of an alarm local storage of the images in question and/or the transfer thereof to a central unit occurs, and where transfer is necessary, it is effected via a wired or wireless bi-directional communication connection.

In yet a further preferred embodiment of the object protection device according to the present invention, a passive infrared sensor is used, the signals of which are linked to those of the imaging sensor. Separate pre-processing of these signals preferably takes place before linking the signals of the passive infrared sensor and the imaging sensor.

In a further preferred embodiment of the device according to the present invention, the images of the imaging sensor are examined for changes with respect to a reference image. The reference image is preferably a periodically updated background image, or a chronologically delayed image. In a first possible evaluation, moved objects are identified and followed-up and checked as to whether they enter one or more previously defined zones. Additionally, or alternatively, the reference image contains stable features of the object to be monitored, extracted in a learning process, such as, for example, edge features, and wherein during the active operational state of the device, checking of the images for the presence of these stable features, and thus for the presence of the object to be monitored, takes place.

### BRIEF DESCRIPTION OF THE DRAWINGS

The present invention is disclosed in greater detail herein below in connection with embodiments illustrated in the drawings, in which:

FIG. 1 illustrates a block diagram of an object protection device according to the invention;

FIGS. 2, 2b illustrate a first example of an application of the device of FIG. 1; and

FIG. 3 illustrates a second example of an application of the device of FIG. 1.

### DETAILED DESCRIPTION OF THE INVENTION

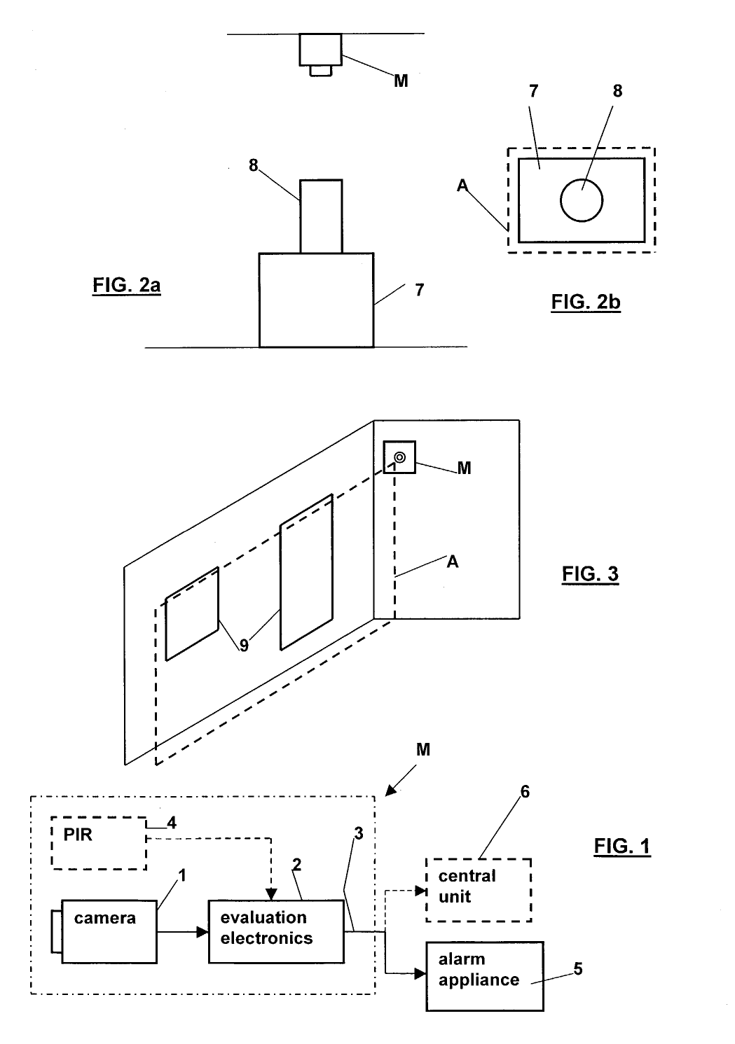

As shown in FIG. 1, the object protection device according to the present invention, designated as detector M, has an imaging sensor 1 formed by a CMOS image sensor, and evaluation electronics 2 integrated therein, or connected thereto, with an alarm output 3. Optionally, a passive infrared (PIR) sensor 4 can be provided, the signals of which are also supplied to the evaluation electronics 2. If desired, a level (not illustrated) for separate pre-processing of the signals of the two sensors 1 and 4 can be provided in each case between the imaging sensor 1 and the evaluation electronics 2, and between the PIR sensor 4 and the evaluation electronics 2.

The imaging sensor 1 is focused onto the object to be protected and its surrounding environment. The object is detected by image technology which digitizes the image. When switched to high definition, at intervals of fractions of a second, the imaging sensor 1 in each case makes an image which is evaluated according to known methods either alone or together with the signal of the PIR sensor 4. The cooperation of the imaging sensor 1 with the PIR sensor 4 is discussed in EP-A-O 939 387 (U.S. Pat. No. 6,396,534 B1), which reference is incorporated herein by reference. This reference discloses the function of the levels referred to above for separate preprocessing of the signals of the two sensors 1 and 4.

The alarm output 3 is connected to a local alarm appliance 5 which can be a siren actuatable via a relay and separate from the detector M, a flashing light, a miniature siren built into the detector M, or a voice synthesizer for programmed voice output. Alternatively or additionally, the alarm output 3 can be connected to a central unit 6 via a suitably wired or wireless connection, this connection preferably being constructed as bi-directional.

A method for the evaluation of the image of the imaging sensor 1 first involves an examination by known methods, such as, for example, pixel differences of the raw or filtered image data, and comparison of features (average value, variance, edges, etc.) of pixel groups for changes in respect of a reference image, thereby localizing moving objects. Therefore, the reference image can be a periodically updated background image, or a chronologically delayed image. Thereafter, certain features (for example size, location, geometric moments) of the moving objects are calculated and followed-up based on such calculation. Relevant data, such as size, speed and the like can then be derived therefrom for objects approaching the protected object, with pre-alarm with alarm data obtained therefrom.

The signal of any PIR sensor 4 present is evaluated for amplitude, frequency and any other parameters, from which certain features of an object, such as, for example, its speed, the duration of its presence, etc. can be estimated. The signals of the two sensors 1 and 4 can be evaluated individually and then combined intelligently. In this way the false alarm rate can be reduced by evaluation of the signals of several sensors based on different basic physical principles with constant detection security.

In another approach to the evaluation of the signal of the imaging sensor 1, the image is evaluated to determine whether the object to be protected has changed or moved. Here, stable features of the object (edges, for example) are extracted in a learning module, and in the active operating state of the detector M the image is then checked as to whether the stable features are still present. If this proves not to be the case, it is assumed that the object to be protected has been moved, and an alarm is triggered.

The image provided by the imaging sensor 1 can also be checked for its integral brightness, and an alarm can be triggered if a maximum brightness is exceeded, or a minimum brightness is not achieved. The former would mean that the imaging sensor 1 has been dazzled, and the latter would indicate that the lighting in the exhibition room has been diminished.

Naturally, different evaluation methods can be combined in any suitably convenient manner.

Further, during installation of the detector M, or after a change in the objects to be protected, the zones corresponding to the different alarm levels (alarm, pre-alarm) can be freely defined in the monitored room. It is also possible to put the detector M into a learning mode in which it sets the alarm levels automatically or with external support. Further parameterization of the detector M (e.g. minimum size of object, with/without pre-alarm, etc.) is also possible after installation has taken place.

In FIGS. 2 and 3, two possible examples of the application of the detector M in connection with museums/exhibitions are illustrated. FIG. 2a shows a detector M, installed on the ceiling of a room, which acts as security device for a sculpture 8 displayed on a plinth 7. The detector M “looks” at the sculpture 8 from above, wherein in the image taken by the detector (FIG. 2b) an alarm window, indicated by dotted lines A, is defined. As soon as an object breaks through this alarm window A an alarm is triggered. Correspondingly, a pre-alarm can be triggered if an object moves towards the alarm window A and penetration into the protected zone is imminent.

FIG. 3 shows a detector M mounted on a first wall and provided as a security device for paintings 9 hung on a second wall running perpendicular to the first wall. Here the alarm window A is a virtual wall running at a distance from the second wall and parallel to it.

Set forth below are several modes of operation for the detector M:

The detector M generates an alarm as soon as an object (person) approaches the object to be monitored at a previously defined alarm distance.

The detector generates a pre-alarm as soon as an object (person) approaches the object to be monitored at a previously defined pre-alarm distance. If this pre-alarm can be heard in the exhibition room in question the detector M evaluates the reaction of the person in question in order to trigger a genuine alarm depending on behavior.

The detector generates an alarm as soon as the object to be monitored has moved or changed.

The detector generates an alarm as soon as the room lighting is outside a permitted range (too dark because lighting has been turned off or too light because of dazzling of the detector).

Combination of the aforesaid modes.

In the event of an alarm local storage of the images taken.

In the event of an alarm transfer of the images taken to a central unit for enabling an alarm verification (look-in).

We claim:

1. A security device comprising an imaging sensor for generating images of an object to be protected, and evaluation electronics for evaluating the images, wherein the evaluation electronics are provided in situ in or on the sensor, and together with it form a device whereby evaluation of the images takes place locally and without the need in normal cases to transfer the images to a central unit.

2. The device according to claim 1, wherein the imaging sensor comprises a camera, or CMOS image sensor.

3. The device according to claim 1, wherein the evaluation electronics are integrated into the imaging sensor or connected to it.

4. The device according to claim 1, wherein the imaging sensor is connected to a local alarm apparatus which is triggered by the evaluation electronics.

5. The device according to claim 1, wherein in response to an alarm, local storage of the images and/or transfer thereof to a central unit occurs, and further wherein if transferred there is provided a wired or wireless bidirectional communication connection.

6. The device according to claim 1, further comprising a passive infrared sensor that provides signals which are linked to signals of the imaging sensor.

7. The device according to claim 6, wherein before the signals are linked, separate pre-processing of the signals occurs.

8. The device according to claim 7, wherein the passive infrared sensor signal is evaluated in respect of parameters selected from the group consisting of amplitude, frequency and other parameters from which features of an object such as its speed and duration of its presence can be estimated.

9. The device according to claim 1, wherein the images of the imaging sensor are examined for changes with respect to a reference image.

10. The device according to claim 9, wherein the reference image is a periodically updated background image or a chronologically delayed image.

11. The device according to claim 9, further comprising means for identifying and following moved objects to determine whether they enter a previously defined zone.

12. The device according to claim 9, wherein the reference image contains at least one stable feature of the object to be monitored, and the image is evaluated to determine the presence of said stable feature and the presence of the object to be monitored.

13. The device according to claim 9, wherein at least one of the following modes of operation occurs:
the device generates an alarm as soon as an object approaches the object to be monitored at a previously defined alarm distance;
the device generates a pre-alarm as soon as an object approaches the object to be monitored at a previously defined pre-alarm distance; the device generates an alarm as soon as the object to be monitored has moved or changed; and
the device generates an alarm as soon as lighting in a room is outside a permitted range.

14. The device according to claim 1, wherein the images generated include the object to be protected and its environment.

15. The device according to claim 12, wherein the stable features of the object to be monitored are obtained in a learning process.

16. The device according to claim 12, wherein the stable feature is an edge of the object or a feature of the environment which is monitored.
